(19) United States
(12) Patent Application Publication
(10) Pub. No.: US 2026/0022730 A1
(43) Pub. Date: Jan. 22, 2026

(54) BLIND FASTENING DEVICE FOR FASTENING A PIECE TO A BASE PIECE

(71) Applicant: Specialinsert s.r.l., Torino (IT)

(72) Inventor: Piero Arduini, Torino (IT)

(73) Assignee: Specialinsert s.r.l., Torino (IT)

(21) Appl. No.: 19/078,871

(22) Filed: Mar. 13, 2025

Related U.S. Application Data
(63) Continuation-in-part of application No. 18/779,230, filed on Jul. 22, 2024.

(51) Int. Cl. F16B 37/12; F16B 13/08

(52) U.S. Cl. CPC F16B 37/122; F16B 13/0866

(57) ABSTRACT

A blind fastening device is disclosed for fastening at least one piece to a base piece. The blind fastening device includes a connecting member inserted into a hole in the base piece, the connecting member being connected to the base piece by means of an elastically deformable member. The elastically deformable member is mounted on the connecting member by means of a closing element, wherein the mutual contact surfaces between the closing element and the connecting member are shaped in such a way as to establish a friction fit.

### BACKGROUND OF THE INVENTION

### 1) Field of the Invention

The present invention refers to a self-fastening threaded insert and to a process for assembling a threaded insert. In particular, the present invention refers to a self-fastening threaded insert with respect to a slab of building material.

More particularly, the present invention relates to a blind fastening device for fastening a workpiece to a base workpiece. In general, the present invention relates to dowels or other devices fixed in walls or the like by inserting them into holes drilled therein for that purpose with parts that grip into the hole or behind the back of the wall after insertion from the front combined with an expansion sleeve by the use of an expander fixed by the extraction of a separate part of the expander, driven by a screw, nail or the like.

### 2) Background Art

Generally, a self-fastening threaded insert allows arranging a threaded seat on a slab of building material, such as marble, granite or other stone material, wood, glass and composite material, such as carbon and further new-generation elements of a compact nature known as “solid surfaces”.

Such threaded seat allows fastening the slab to a structure or frame to make vented facades, building coatings, building environments, furniture, sanitary elements, kitchens, funeral works of art, etc.

The prior art, represented for example, by EP 1277973 B1, refers to a small fastening block comprising a cylindrical separating body with an internal drilling. The body is axially divided into two segments, mutually connected by snap-type closures. A separating device is housed in a body recess. However, in order to fasten the small block to the slab, it is necessary to rotate the body with a tool, creating an insertion effect in the slab hole.

US-B1-10473141, of the same Applicant, discloses a self-fastening threaded insert which works only with three or more deformation elements, not being suitable for applications requiring one or two deformation elements.

US-A1-2008/0031702 discloses a prior art insert which is used in other fields of application.

The state of the art is represented by patent application EP 0 819 806 A2 concerning a device for locking cladding panels onto the anchoring means of the wall to be clad.

### SUMMARY OF THE INVENTION

The solution to the problem of maintaining contact between the fixed parts and avoiding the slipping of the same parts is provided by a blind fastening device for fixing a piece to a base piece by means of a friction fit.

A friction fit occurs when two contact surfaces fit together in such a way as to create a frictional resistance that prevents relative movement between them. In the context of closures and connecting elements, the mutual contact surfaces are shaped in such a way as to obtain a friction fit.

The object of this type of fitting is to ensure that the locking element and the connecting member remain firmly connected without requiring the use of additional screws, bolts or other fasteners. The contact surfaces can be designed with complementary shapes, such as grooves and protuberances, which fit together to create a friction seal.

The friction generated between the contact surfaces helps keep the closure element and the connecting member stable, preventing them from loosening or separating under normal loads or stresses. This type of friction fit is often used in applications where quick and easy assembly is needed without the use of additional tools or hardware.

The above and other objects and advantages of the invention, as will result from the following description, are achieved with a blind fastening device for fastening a workpiece to a base workpiece such as that described in claim 1. Preferred embodiments and non-trivial variants of the present invention form the subject matter of the dependent claims.

It is understood that all attached claims form an integral part of this description.

It will be immediately obvious that countless variations and modifications can be made to what is described (for example relating to shape, dimensions, arrangements and parts with equivalent functionality) without departing from the scope of the invention as it appears from the attached claims.

### BRIEF DESCRIPTION OF THE DRAWINGS

The present invention will be better described by some preferred embodiments thereof, provided as a non-limiting example, with reference to the enclosed drawings, in which:

FIG. 1 shows a perspective view of a first embodiment of the self-fastening threaded insert according to the present invention;

FIGS. 1A and 1B shows partially sectioned side views along the axis of symmetry respectively of a second and a third embodiment of the self-fastening threaded insert according to the present invention;

FIGS. 1C to 1E show partially sectioned side views along the axis of symmetry of some installation modes of the self-fastening threaded insert according to the present invention;

FIGS. 2 to 5 show partially sectioned side views along the axis of symmetry respectively of various embodiments of the self-fastening threaded insert according to the present invention;

FIG. 6 shows a perspective view of a sectioned portion of a slab adapted to house the self-fastening threaded insert according to the present invention;

FIG. 7 shows a perspective view of the slab of FIG. 6 coupled with an embodiment of the self-fastening threaded insert according to the present invention; and

FIG. 8 shows a partial and enlarged side sectional view of an embodiment of the self-fastening threaded insert equipped with an external connection element screwed according to the present invention.

FIG. 9 shows a sectional view of an embodiment in operating mode of the blind fastening device for fastening a workpiece to a base workpiece according to the present invention;

FIG. 10 shows an exploded view of an embodiment of the device of the previous figure;

FIG. 11 shows an orthogonal projection view of a relevant element of the previous figure;

FIGS. 12 through 16 show a variant of FIG. 11; and

FIG. 17 shows a plan view of a solution applied to a relevant component of the blind fastening device for fastening a workpiece to a base workpiece according to the present invention.

### DETAILED DESCRIPTION OF PREFERRED EMBODIMENTS

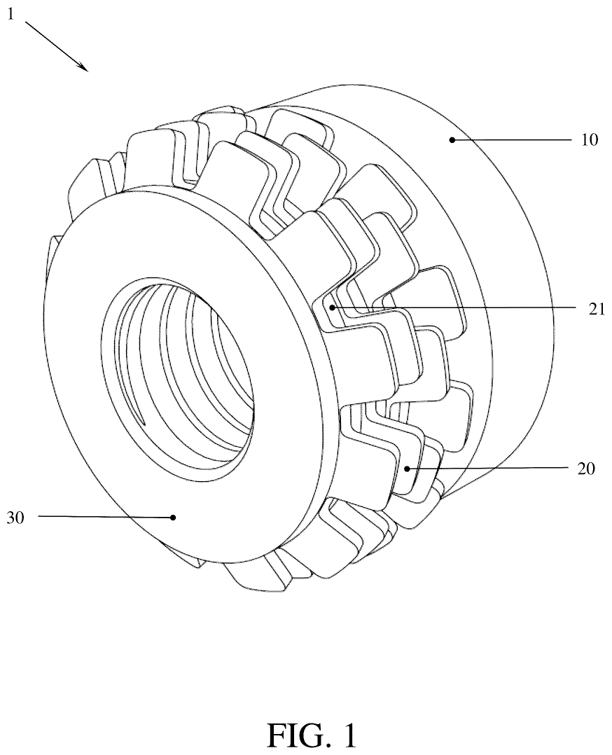

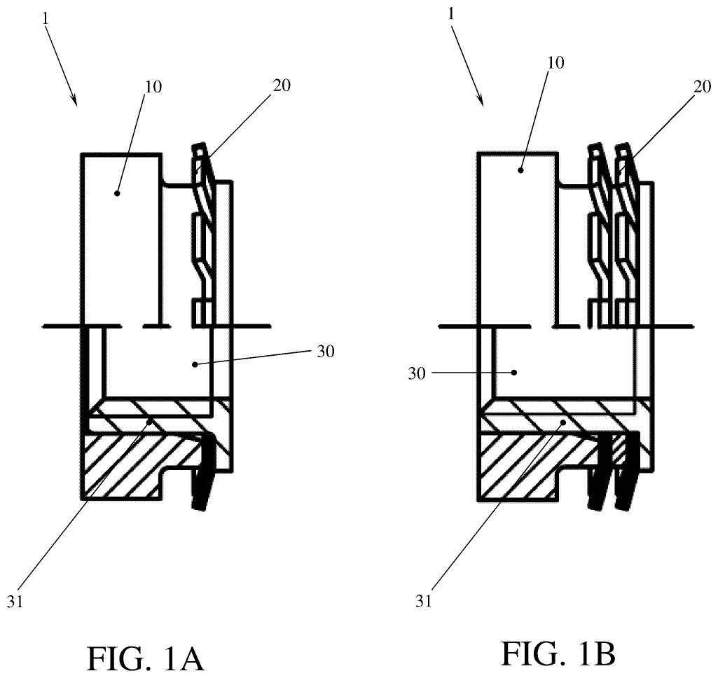

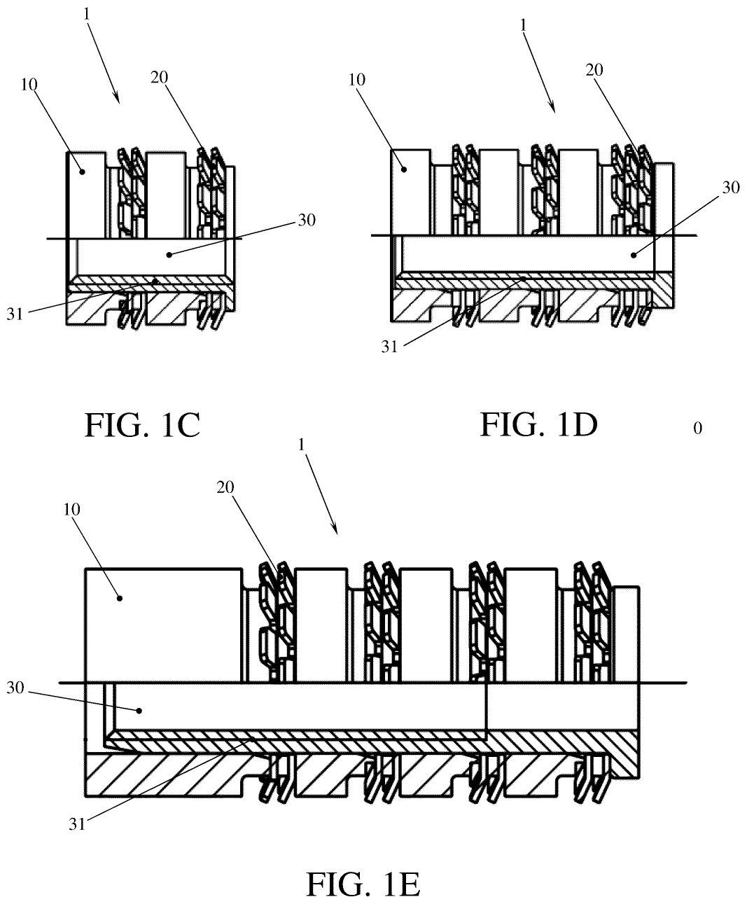

With reference to FIGS. 1, 1A, 1B, 2 and 3, it is possible to note that a threaded insert 1 with automatic fastening with respect to a slab of building material comprises a bearing element 10 with respect to the slab, at least one deformation element 20 adapted to interact with the slab, and a supporting element 30 cooperating with the bearing element 10.

While FIGS. 1 and 4 show a first embodiment of the threaded insert 1 with (for example) four deformation elements 20, FIG. 1A shows a second embodiment of the threaded insert 1 with (for example) one deformation element 20, and FIG. 1B shows a third embodiment of the threaded insert 1 with (for example) two deformation elements 20.

FIGS. 1C to 1E show partially sectioned side views along the axis of symmetry of some installation modes of the self-fastening threaded insert 1 according to the present invention, where the insert 1 can be installed two at a time (FIG. 1C), three at a time (FIG. 1D) or four at a time (FIG. 1E); obviously, the above are only some of the several possible embodiments in which the insert 1 can be installed, in any of its possible configurations with more than four deformation elements 20.

Advantageously, such deformation element 20 is deformed due to the effect of an external load transmitted by the supporting element 30. In this way, such deformation element 20 can transmit to the slab forces which are perpendicular to an application force of the external load, to allow the threaded insert 1 to get fastened to the slab.

Advantageously, the supporting element 30 can support a battery of deformation elements 20, preferably in a number ranging from 1 to 4 elements connected in series or more, depending on applications.

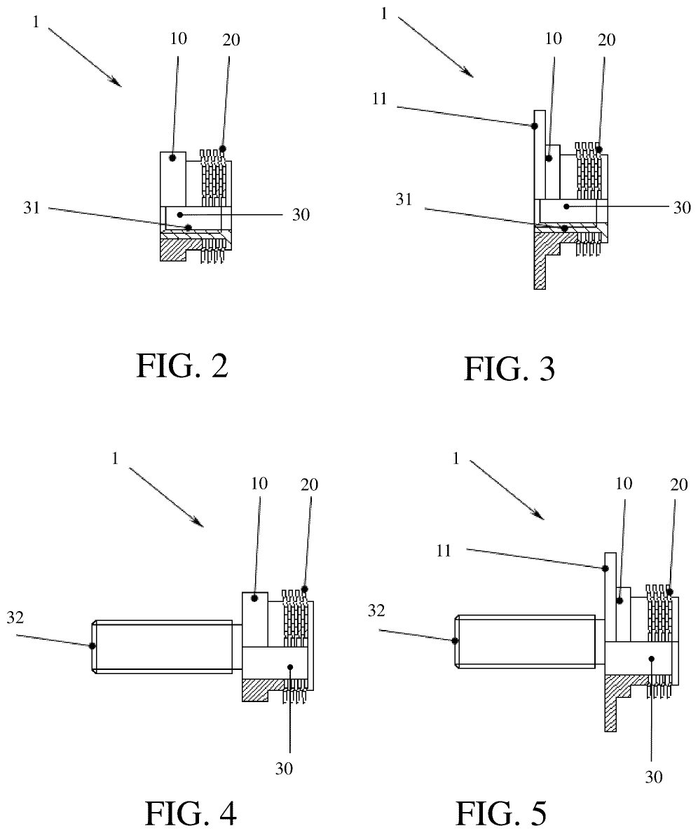

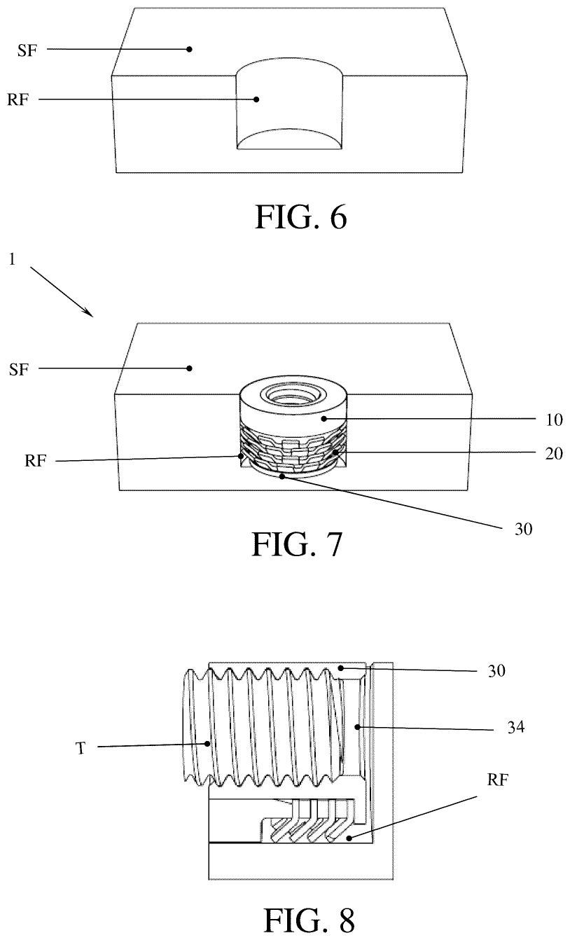

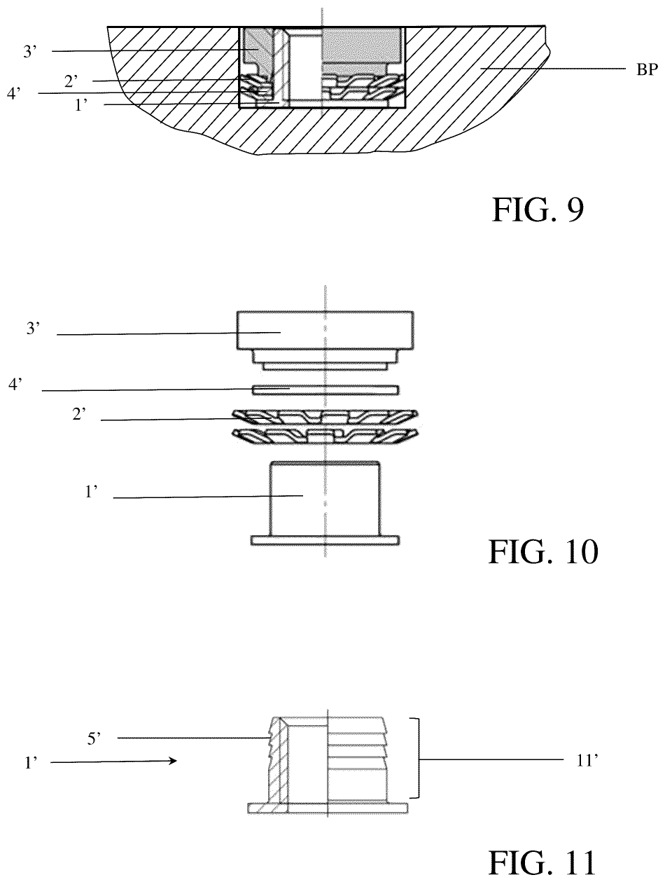

With reference to FIGS. 2, 4, 6 and 7, it is possible to note that the bearing element 10 adapted to contain the supporting element 30 is housed in a recess of the slab to allow the threaded insert 1 to abut against an internal surface RF of the recess without projecting from an external face SF of the slab.

With reference to FIGS. 3, 5 and 6, it is possible to note that the bearing element 10 adapted to contain the supporting element 30 comprises an abutment flange 11 with respect to an external face SF of the slab to allow the threaded insert 1 to abut at least against the external face SF of the slab.

At least one of such deformation elements 20 can comprise an elastic toothed crown, adapted to be housed with interference in a cylindrical recess of the slab.

Alternatively, each deformation element 20 can comprise a smooth or toothed cup spring which is smooth or toothed or with another suitable shape, adapted to be housed with interference in a cylindrical recess of the slab (not shown).

According to a preferred configuration, each deformation element 20 can be connected to at least one spacer ring 21, as shown in FIG. 1.

With reference to FIG. 8, it is possible to note that the supporting element 30 comprises abutting means 34 adapted to block a connection element T screwed to the threaded insert 1 to prevent the threaded insert 1 from going out of the recess of the slab and to prevent the slab from breaking.

Preferably, the abutting means 34 can comprise a blind threaded hole or a partially threaded through-hole to prevent a screw T from pressing onto the bottom of the recess of the slab.

With reference to FIGS. 2 to 5, the threaded insert 1 can alternatively operate as connection element through an internal threading 31 and an external threading 32.

The bearing element 10 made of plastic or metallic material, depending on the application, and the supporting element 30 made of metal allow supporting loads with a high force.

A process for assembling a self-fastening threaded insert 1 with respect to a slab of building material comprises the steps of:
performing an excavation of the slab to obtain a receiving recess;
applying the threaded insert 1 into the receiving recess to allow fastening the bearing element 10 to the slab and housing with interference, with respect to an internal wall RF of the recess of the slab, each deformation element 20 belonging to the threaded insert 1;
connecting an external element through a connection element T screwed onto the threaded insert 1.

The threaded insert 1 allows obtaining the objects of the invention, with the advantages of allowing an assembling after having performed a simple hole on the slab, even when working, with the use of standard tools, being able to quickly insert the threaded insert into such hole through a simple pressure, without having to add adhesives and gluing agents.

Moreover, the threaded insert of the invention allows performing an assembling of the threaded insert which afterwards disappears inside the slab, without external encumbrances, facilitating handling and storage of the slabs.

A further advantage is given by the absence of stresses on the receiving material when the threaded insert is not stressed, while during its use the elastic washers are stressed by an axial traction force, radially acting against the walls due to flexure and pressure, preventing the insert from going out of the slab.

The threading of the supporting element made as non-through ensures the fastening of the threaded insert onto the slab, avoiding the extraction effect generated by the possible inappropriate length of the screw.

Referring to the Figures, it can be noted that a blind fastening device for fastening at least one workpiece to a base piece BP comprises a connecting member 1 inserted into a hole of the base piece BP.

The connecting member 1′ is connected to the base piece BP by elastically deformable means 2′ which are mounted on the connecting member 1′ by means of a closing element 3′.

Advantageously, the mutual contact surfaces between the closing element 3′ and the connecting member 1′ are shaped in such a way as to establish a friction fit.

The connecting member 1′ consists of a flanged bushing on the side that abuts the bottom of the base piece BP.

The elastically deformable means 2′ consist of at least one elastic washer inserted onto the connecting member 1′.

The closing element 3′ abutting the elastically deformable means 2′ consists of a perforated cylindrical block inserted along the connecting member 1′.

An external surface 11′ of the connecting member 1′ is suitably corrugated at least in the portion in contact with the internal surface of the perforated cylindrical block of the closing element 3′.

The closing element 3′ is made of nylon, plastic, or any other material.

The elastically deformable means 2′ comprise at least one rigid spacer element 4′.

According to a preferred configuration, the external surface 11′ is shaped with a sawtooth profile 5′ (as can be seen, for example, in FIG. 11).

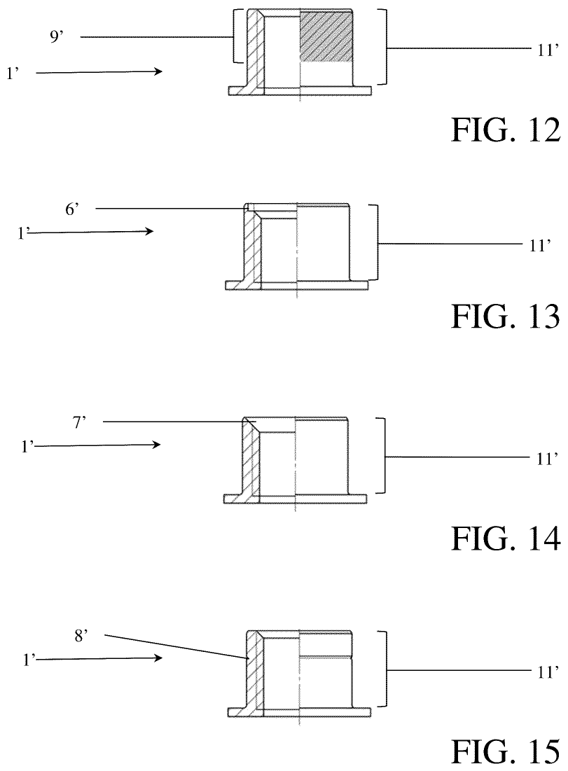

According to a further configuration, the external surface 11′ is shaped with a knurling 9′ (as can be seen, for example, in FIG. 12).

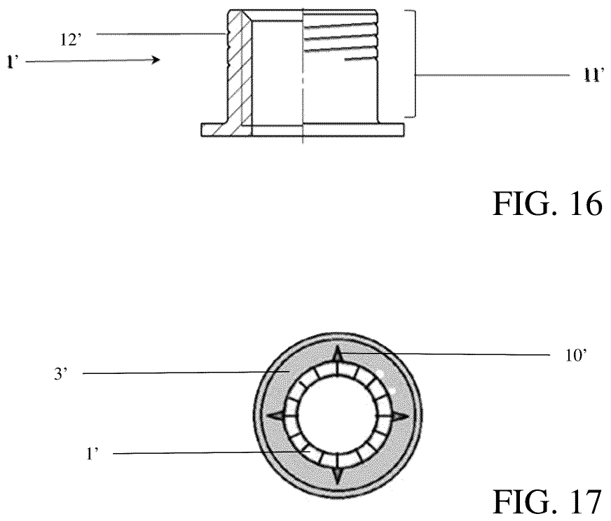

Furthermore, it is possible to combine the sawtooth and knurled configurations with one of the following solutions: the connecting member 1′ shaped with a countersink 6′ on the edge of the protruding part to allow the riveting process on the closing element 3′ (as can be seen, for example, in FIG. 13); the connecting member 1′ shaped with a countersink 7′ on the edge of the protruding part to allow the riveting process on the closing element 3′ (as can be seen, for example, in FIG. 14); the connecting member 1′ comprising a seat 8′ to allow the snap-in positioning of the closing element 3′ (as can be seen, for example, in FIG. 15); the external surface 11′ is shaped with a helical profile 12′ (as can be seen, for example, in FIG. 16).

The edge of the closing element 3′ can be provided with a series of ridges 10′ arranged flush with the edge of the connecting member 1′ (as can be seen, for example, in FIG. 17).

Some embodiments of the invention have been described, but naturally they are susceptible to further modifications and variations within the scope of the same inventive idea.

1. A blind fastening device for fastening at least one piece to a base piece, comprising a connecting member inserted into a hole in the base piece, the connecting member being connected to the base piece by means of elastically deformable means, the elastically deformable means being mounted on the connecting member by means of a closing element, wherein the mutual contact surfaces between the closing element and the connecting member are shaped in such a way as to establish a friction fit.

2. The device of claim 1, wherein the connecting member is constituted by a flanged bushing on the part abutting the bottom of the base piece, the elastically deformable means being constituted by at least one elastic washer inserted onto the connecting member, the closing element abutting against the elastically deformable means being a perforated cylindrical block inserted along the connecting member, an external surface of the connecting member being suitably corrugated at least in the portion in contact with the internal surface of the perforated cylindrical block of the closing element.

3. The device of claim 2, wherein the closing element is made of nylon, plastic, or any other material.

4. The device of claim 1, wherein the elastically deformable means comprise at least one rigid spacer element.

5. The device of claim 1, wherein the external surface is shaped with a sawtooth profile.

6. The device of claim 1, wherein the external surface is shaped with a knurling.

7. The device of claim 1, wherein the connecting member is shaped with a facing on the edge of the protruding part to allow the riveting process on the closing element.

8. The device of claim 1, wherein the connecting member is shaped with a flare of the edge of the protruding part to allow the riveting process on the closing element.

9. The device of claim 1, wherein the connecting member comprises a seat to allow the snap-in positioning of the closing element.

10. The device of claim 1, wherein the external surface is shaped with a helical profile.

11. The device of claim 1, wherein the edge of the closing element is provided with a series of grooves arranged flush with the edge of the connecting member.
